(19) United States
(12) Patent Application Publication
(10) Pub. No.: US 2009/0111518 A1
(43) Pub. Date: Apr. 30, 2009

(54) INTERFACE FOR CELLULAR AND LOCAL NON-CELLULAR COMMUNICATIONS

(75) Inventors: Neha Agrawal, Bangalore (IN); Nitin Awasthi, Bangalore (IN)

Correspondence Address: MENDELSOHN & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 11/926,517

(22) Filed: Oct. 29, 2007

(51) Int. Cl. H04B 1/28; H04B 7/00; H04M 1/00

(52) U.S. Cl. 455/557; 455/41.2; 455/426.1; 455/426.2

(57) ABSTRACT

Interface apparatus supports communications between a cellular network and a local non-cellular network, such as a Bluetooth, cordless phone, or PBX network. In an exemplary embodiment, the interface apparatus connects a conventional cellular phone to the base of a conventional cordless phone set. By placing the cordless phone, interface apparatus, and cordless phone base at a location of acceptable cellular signal strength, a user may communicate with the cellular network via the cordless phone set using the cordless phone's handset, even in locations of low cellular signal strength. The orientation of the interface apparatus may be (manually or automatically) controlled using a motorized base to optimize reception of cellular signals.

### BACKGROUND OF THE INVENTION

1. Field of the Invention

The present invention relates to cellular telephony devices, and specifically to addressing problems related to weak cellular signal strength.

2. Description of the Related Art

Cellular telephone technology is often plagued by the problem of users not being able to receive strong cellular signals in all locations of desired cellular phone use. Prior-art attempts to solve the problem of weak cellular signal connectivity at the location of a user's cellular telephony device have included a variety of means, including but not limited to having the user position and orient him- or herself so that the device's cellular antenna can receive a sufficiently strong signal from a nearby cellular tower. These prior-art attempts to solve the problem have suffered from numerous disadvantages, including but not limited to restriction on the user's mobility and poor reception whenever the device's antenna is not correctly positioned or oriented.

### SUMMARY OF THE INVENTION

In one embodiment of the invention, a method and an interface apparatus interconnect a cellular communication network and a local non-cellular communication network. Incoming cellular signals received from the cellular network are converted into incoming non-cellular signals for transmission to the local non-cellular network, and outgoing non-cellular signals received from the local non-cellular network are converted into outgoing cellular signals for transmission to the cellular network.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram illustrating one embodiment of the present invention in which a user's Bluetooth-enabled cellular telephony device is configured with an exemplary interface apparatus of the present invention;

FIG. 2 is a simplified block diagram of the component-level elements that constitute the docking station of FIG. 1;

FIG. 3 is a flow diagram illustrating an exemplary algorithm that can be used by the station controller of FIG. 2 to control the orientation of the docking station of FIG. 1 in the manual mode of operation;

FIG. 4 is a flow diagram illustrating an exemplary algorithm that can be used by the station controller of FIG. 2 to control the orientation of the docking station of FIG. 1 in the automatic mode of operation, which automatically optimizes cellular signal reception;

FIG. 5 illustrates another embodiment of the present invention, in which a user cradles his or her cellular phone into a cradle-enabled docking station and communicates with the docking station using a separate Bluetooth device;

FIG. 6 is a simplified block diagram of the component-level elements that constitute the docking station of FIG. 5;

FIG. 7 illustrates another embodiment of the present invention, in which conventional cordless telephony technology is used in place of the Bluetooth connectivity of the previously described embodiments;

FIG. 8 is a high-level block diagram of the circuitry used to implement the interface device, the conventional cellular phone, and the conventional cordless phone base and handset of FIG. 7;

FIG. 9 is a flow diagram illustrating continuous processing in which the interface device of FIG. 7 converts incoming cellular telephone signals received from the cellular phone into incoming PSTN telephone signals for transmission to the cordless phone base;

FIG. 10 is a flow diagram illustrating continuous processing in which the interface device of FIG. 7 converts outgoing PSTN telephone signals received from the cordless phone base into outgoing cellular telephone signals for transmission to the cellular phone;

FIG. 11 illustrates another embodiment of the present invention in which an interface device is used to connect a conventional GSM-compatible cellular phone to a conventional PBX switch; and

FIG. 12 is a high-level block diagram of the circuitry used to implement the interface device, conventional GSM cellular phone, and conventional PBX switch of FIG. 11.

### DETAILED DESCRIPTION

Problems in the prior art are addressed in accordance with the principles of the present invention by providing interface apparatus that supports communications between cellular and local non-cellular telephony devices. In certain embodiments of the present invention, the interface apparatus converts incoming cellular signals received by a user's cellular telephony device (e.g., a conventional mobile phone) from a cellular network into incoming non-cellular signals for transmission to the user's non-cellular telephony device (e.g., a conventional cordless phone). The interface apparatus also converts outgoing non-cellular signals received from the user's non-cellular device into outgoing cellular signals for transmission by the user's cellular device via the cellular network. The interface apparatus enables the user's cellular device to be located at a position and/or orientation that provides an at least functional if not optimal level of cellular communications between the cellular device and the cellular network, while enabling the user to move away from the location of the cellular device and still communicate with the cellular network due to the non-cellular link between the user's non-cellular device and the interface apparatus.

As used in this specification, the term “cellular network” refers to a radio network made up of a number of radio cells (or just cells), each served by a fixed transmitter, known as a cell site or base station. These cells are used to cover different areas in order to provide radio coverage over a wider area than the area of one cell. A “cellular device,” referred to in the above context and commonly known as a mobile phone or cell phone, is a long-range, portable electronic device used for mobile communication in a cellular network.

Similarly, the term “non-cellular” refers to any suitable local-area communication including but not limited to Bluetooth telephony, standard cordless or wired telephony, private branch exchange (PBX) telephony, or any of their equivalents. The term “Bluetooth” typically refers to a chip-based open industry standard for wireless connectivity among telephony devices and computing devices using short-range radio links in the 2.4 GHz range, the so-called ISM (Instrumentation, Scientific, and Medical) “free band.” As used in this specification, the term “Bluetooth” refers to any suitable wireless universal serial bus (WUSB) telephony.

### Bluetooth Telephony Applications

FIG. 1 is a block diagram illustrating one embodiment of the present invention in which a user's Bluetooth-enabled cellular telephony device is configured with an exemplary interface apparatus 100 of the present invention. In this embodiment, the user's cellular device includes Bluetooth-enabled handset 130 and SIM card 132. When configured for prior-art cellular communications, SIM card 132 is mounted within handset 130. For the configuration of FIG. 1, however, SIM card 132 is removed from handset 130, such that handset 130 functions as a Bluetooth-only device with its cellular communication capability disabled.

As shown in FIG. 1, interface apparatus 100 includes docking station 110 connected to motorized base 120. Docking station 110 includes cellular antenna 112, non-cellular (in this embodiment, Bluetooth) antenna 114, and SIM-card port 116, which receives SIM card 132. With SIM card 132 inserted within SIM-card port 116, interface apparatus 100 is configured to support cellular communications with the cellular network via link 102 as well as non-cellular (Bluetooth) communications with handset 130.

In particular, cellular antenna 112 receives an incoming cellular signal from the cellular network via cellular link 102, which signal is converted into an incoming Bluetooth signal by circuitry—such as a Bluetooth chip or equivalent mechanism as described further herein below—that is located within docking station 110, according to processes generally described below, for rebroadcast via Bluetooth antennae 114 and Bluetooth link 104 to Bluetooth-enabled handset 130. In addition, an outgoing Bluetooth signal is sent by handset 130 to docking station 110, via Bluetooth link 104 and Bluetooth antennae 114, for conversion by the circuitry within docking station 110 into an outgoing cellular signal for broadcast via cellular antenna 112 and cellular link 102 to the cellular network.

By positioning and orienting docking station 110 at a location that receives cellular signals of strength sufficient to support cellular communications between docking station 110 and the cellular network, handset 130 can be operated by the user within a local-area Bluetooth broadcast vicinity of docking station 110, even at user locations where the strength of the incoming cellular signal is insufficient for cellular communications. The user performs cellular telephony functions using handset 130 without having to suffer undesirable fluctuations in, or undesirably low strengths of, the cellular signals at locations within the vicinity of docking station 110.

Examples of Bluetooth-enabled telephony devices that can be used instead of handset 130 in alternative implementations of the embodiment of FIG. 1 include, but are not limited to, wireless PDAs, headsets, tablet PCs, and even more sophisticated computing devices such as laptop and desktop computers or their peripheral devices.

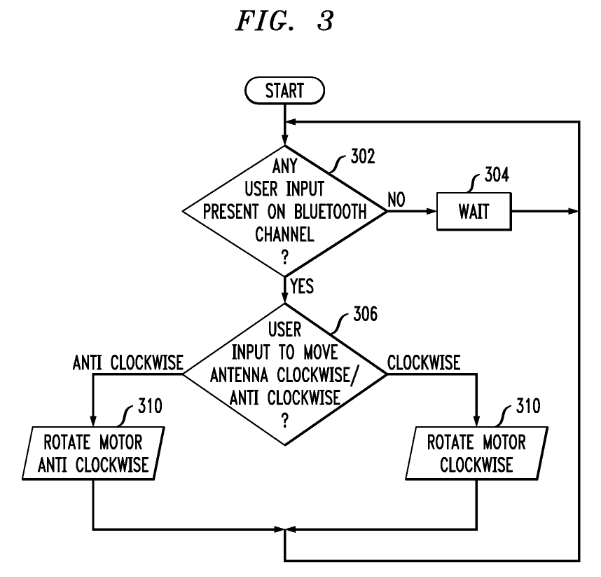

In one implementation of the embodiment of FIG. 1, interface apparatus 100 supports both manual and automatic control over the orientation of docking station 110. In manual control mode, the user uses handset 130 to transmit commands, via Bluetooth link 104 and Bluetooth antennae 114, to instruct motorized base 120 (attached to docking station 110) to rotate docking station 110 in either a clockwise or counterclockwise direction, thereby adjusting the orientation of cellular antennae 112. Processes and algorithms for converting signals from handset 130 into commands for controlling motorized base 120 are explained more fully below in connection with FIG. 3.

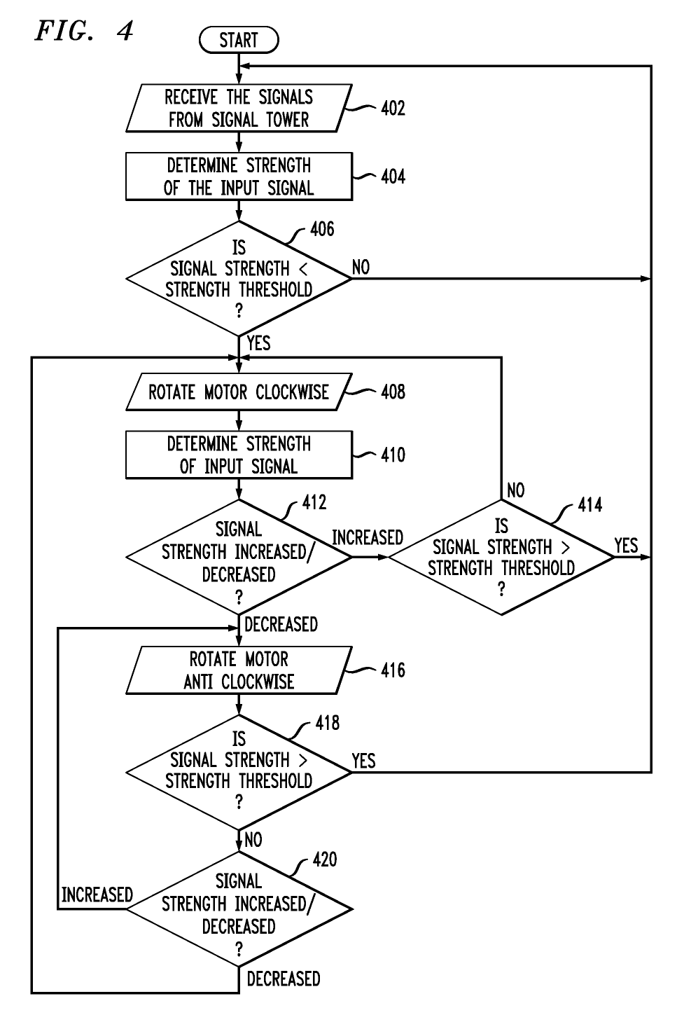

In automatic control mode, motorized base 120 is automatically driven, e.g., by one or more servomotors located within motorized base 120 to optimize the orientation of docking station 110 according to processes more fully described below in connection with FIG. 4.

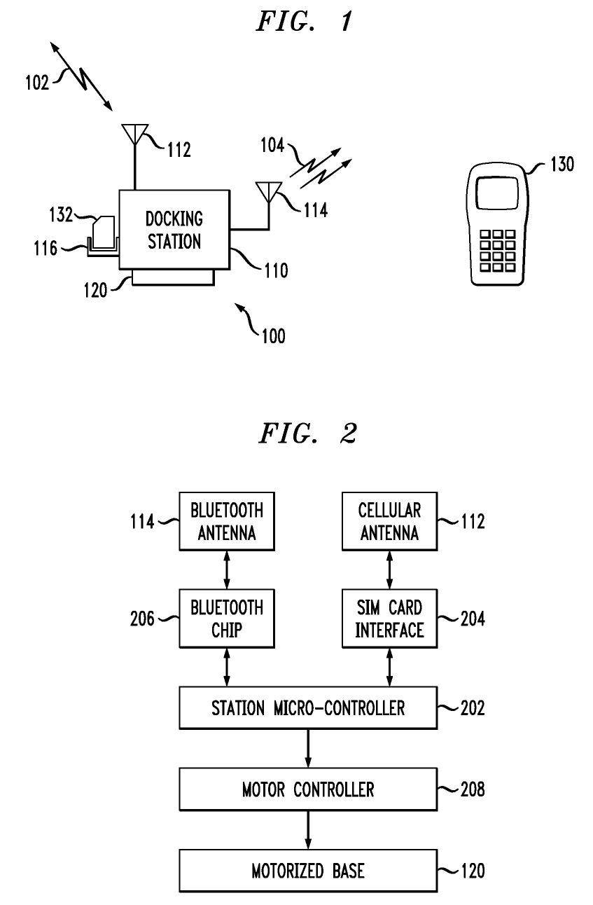

FIG. 2 is a simplified block diagram of the component-level elements that constitute docking station 110 of FIG. 1. The elements shown in FIG. 2 support, under the overall control of (e.g., microcontroller-based) station controller 202, two basic functions of docking station 110: (1) conversion between cellular signals and Bluetooth signals and (2) control of motorized base 120.

For conversion between cellular and Bluetooth signals, SIM card interface 204 interfaces with the user's SIM card 132 mounted in SIM-card port 116 of FIG. 1 to support cellular communications with the cellular network. In addition, Bluetooth chip 206 converts incoming cellular signals received at cellular antenna 112 into signals for transmission as Bluetooth signals via Bluetooth antenna 114. Bluetooth chip 206 also converts outgoing Bluetooth signals received at Bluetooth antenna 114 into signals for transmission as cellular signals via cellular antenna 112. An example of Bluetooth chip 206 is the BRF6100 Bluetooth transceiver from Texas Instruments of Dallas, Tex.

For control of motorized base 120, motor controller 208 generates and transmits motor-control signals to motorized base 120 based on instructions received from station controller 202. In manual mode, station controller 202 generates those instructions based on user commands received at Bluetooth antenna 114 from handset 130, as described below in conjunction with FIG. 3. In automatic mode, station controller 202 generates the instructions for motor controller 208 automatically, based on the strength of the cellular signals received at cellular antenna 112, as described below in conjunction with FIG. 4.

FIG. 3 is a flow diagram illustrating an exemplary algorithm that can be used by station controller 202 to control the orientation of docking station 110 in the manual mode of operation. Flow loops continuously between step 302, where a determination is made whether a user command has been received to rotate the docking station, and step 304, where a wait routine is executed, until such a user command is received. In one implementation, a user command will be in the form of an instruction to rotate either clockwise or counterclockwise. Step 306 distinguishes one form of the instruction from another, and flow passes either to step 308 or to step 310, where clockwise or counterclockwise rotations, respectively, of the docking station are executed by motorized base 120.

FIG. 4 is a flow diagram illustrating an exemplary algorithm that can be used by station controller 202 to control the orientation of docking station 110 in the automatic mode of operation, which automatically optimizes cellular signal reception. The process begins with step 402 of receiving cellular signals from the cellular network via cellular antenna 112. Next, a determination 404 is made of the strength of the received cellular signal, which determination is supported by conventional cellular processing implemented by docking station 110 with SIM card 132 installed, and a comparison 406 to a specified received signal strength threshold is conducted. The specified threshold corresponds to a signal strength level sufficient to support cellular communications with the cellular network.

If the received signal strength is greater than or equal to the specified threshold, then flow passes back to step 402. If the received signal strength is lower than the specified threshold, then flow passes to step 408, wherein a command is sent to motor controller 208 to drive motorized base 120 clockwise by one predefined angular unit. Then, in step 410, the strength of the received cellular signal is again determined.

In step 412, a signal-strength comparison is made between the most recently received signal from step 410 and the signal received immediately prior. If the signal strength has increased at step 412, then the current signal strength is compared, in step 414, to the specified signal strength threshold. Flow returns to step 402, if the current signal strength is greater than the specified threshold level. Otherwise, flow returns to step 408, wherein the motor is rotated clockwise by another angular unit and flow continues on to step 410 as described previously.

If the signal strength has decreased at step 412, then a command is sent to motor controller 208 in step 416 to drive motorized base 120 anticlockwise by one predefined angular unit. After the anticlockwise rotation, the strength of the current signal is compared to the specified threshold level in step 418. If the comparison reveals a current signal strength of acceptably high level, then flow is once again returned to step 402, where the process is repeated.

If the signal strength is still unacceptably low at step 418, then another strength comparison is made, at step 420, between the most recently received signal, from step 418, and the signal immediately prior. If the signal strength has increased as a result of the motor's anticlockwise rotation, then flow is directed back to step 416 for another anticlockwise rotation. If the comparison at step 420 indicates that the signal strength has decreased as a result of the anticlockwise rotation, then flow is returned to step 408, where the motor is rotated clockwise instead in the expectation that an increasing strength gradient will be found thereby.

Those skilled in the art will appreciate that modifications can be made to the algorithm shown in FIG. 4 to prevent chatter or ping-ponging back and forth between clockwise and counterclockwise rotations, when an acceptable level of signal strength is never found. In addition, station controller 202 may support a signal scanning procedure in which station controller 202 commands motor controller 208 to drive motorized base 120 through a full 360-degree rotation (either clockwise or counterclockwise) to determine one or more orientations of peak signal strength. This information can then be used, for example, to determine a suitable value for the specified signal strength threshold as well as to select and establish an initial orientation for docking station 110. After establishing such an initial orientation, the algorithm of FIG. 4 can be implemented to react to changes in the received signal strength that may occur over time.

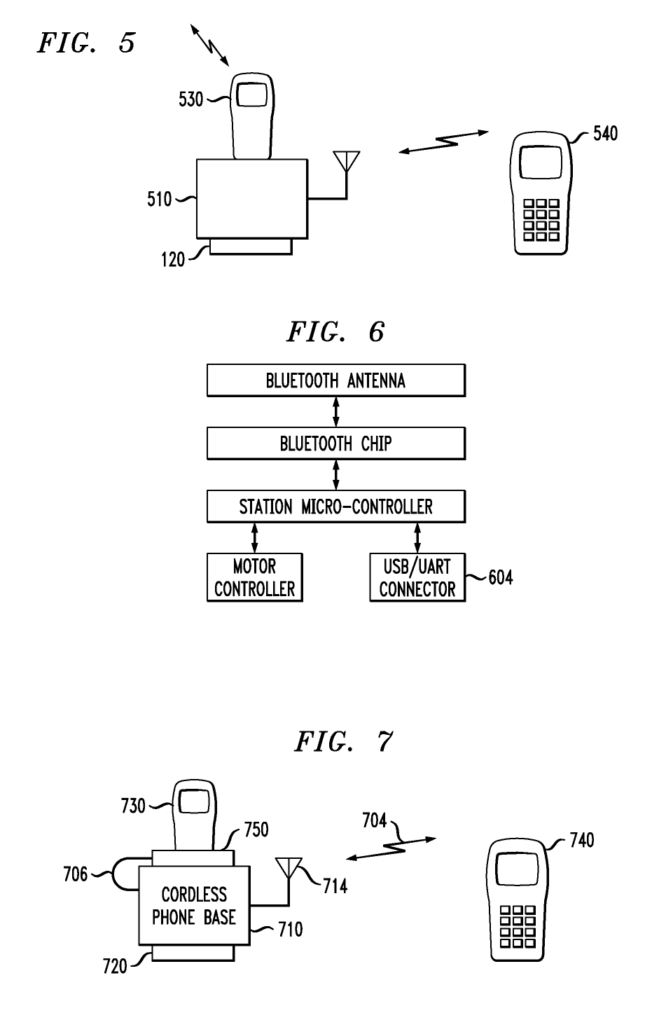

FIG. 5 illustrates another embodiment of the present invention that is similar to the embodiment illustrated in FIG. 1. In the embodiment of FIG. 5, a user cradles his or her cellular phone 530 into docking station 510 and communicates with the docking station using a separate Bluetooth device 540. Docking station 510 is similar in most relevant aspects to docking station 110 of FIG. 1, except that docking station 510 does not have its own cellular antenna. Instead, the cellular antenna of the user's standard cellular phone 530 operates in place of cellular antenna 112 of docking station 110. In addition, docking station 510 does not have a SIM-card port. Instead, the user's standard cellular phone 530 remains configured with its SIM card. All or nearly all other features or mechanisms of the two stations remain highly similar if not substantially identical. The features of the embodiments described in FIGS. 1 and 5 may also be combined into a single interface apparatus, such that the user may choose whether to utilize the cellular antenna attached to the docking station or the cellular antenna of his or her cellular phone. Note that, in this embodiment, cellular phone 530 need not be a Bluetooth-enable device.

FIG. 6 is a simplified block diagram of the component-level elements that constitute docking station 510 of FIG. 5. The elements of docking station 510 are almost identical to those of docking station 110 as illustrated in FIGS. 1-2, except that, instead of cellular antenna 112, SIM-card holder 116, and SIM-card interface 204, docking station 510 contains a standard USB/UART connector 604 that allows for interfacing with cell phone 530. All or nearly all other features or mechanisms of the two stations remain highly similar if not substantially identical. The embodiments of FIGS. 2 and 6 may also be combined into one device to enable the user to select operations utilizing the cellular antenna attached to the docking station or the cellular antenna of his or her cellular phone.

### Cordless Telephony Applications

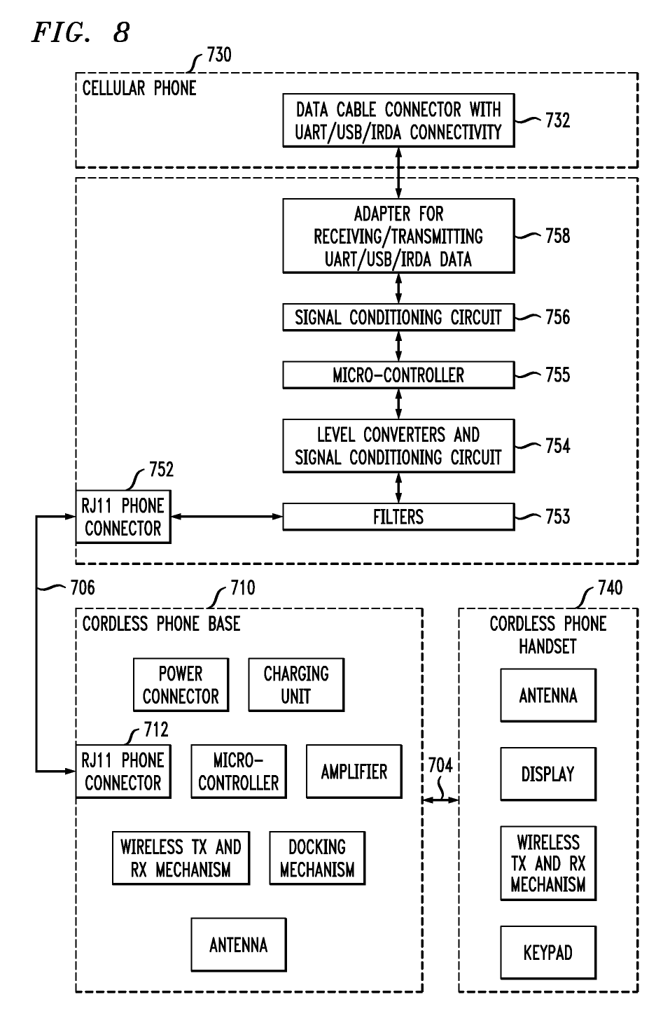

FIG. 7 illustrates another embodiment of the present invention. This embodiment uses conventional cordless telephony technology in place of the Bluetooth connectivity of the previously described embodiments. Using a conventional cordless telephone base 710 (instead of docking station 110/510) and its associated conventional cordless telephone handset 740 (instead of Bluetooth device 130/540), the embodiment of FIG. 7 enables a cellular phone 730 to be configured to cordless telephone base 710 via an interface device 750, the components and operation of which are described below with respect to FIGS. 8-10.

When used for conventional cordless telephony applications, cordless base 710 is connected via a wired (e.g., RJ11) link to a conventional wired telephony network, such as the public switched telephone network (PSTN). When so connected to the PSTN network, cordless base 710 functions as an interface between the PSTN-based telephony signals of the PSTN network and the (e.g., 900-MHz) cordless telephony signals transmitted between cordless base 710 and cordless handset 740 via cordless link 704. When not in use, the cordless handset can be docked to the cordless base, e.g., to recharge the handset battery.

In the embodiment of FIG. 7, interface device 750 converts between the PSTN-based telephony signals associated with cordless base 710 and the cellular signals associated with cellular phone 730. Instead of configuring the cordless base to the PSTN network via a wired link, the same conventional (e.g., RJ11) PSTN port of the cordless base is used to connect the cordless base to interface device 750 via wired link 706. As such, the embodiment of FIG. 7 enables cellular phone 730 to be docked to cordless base 710, via interface device 750, in a location of strong cellular signal receptivity, while the user uses handset 740 anywhere within the cordless telephone range, even in locations with unsatisfactory cellular signal strength, to communicate with the cellular network and even in locations or under situations where there is no PSTN service. In certain implementations, the battery in cellular phone 730 can be recharged when the cellular phone is docked to interface device 750, where interface device 750 is designed to mate with and draw power from the conventional electrodes of cordless base 710.

A motorized base 720, similar to motorized base 120 previously described in connection with FIG. 1, can be attached to cordless base 710 for manual control of the orientation of cellular phone 730. Note that, in this embodiment, motorized base 720 would include the elements and functionality of docking station 110 of FIGS. 1-3 associated with supporting manual control over the orientation of the cellular phone.

FIG. 8 is a high-level block diagram of the circuitry used to implement interface device 750, conventional cellular phone 730, and conventional cordless phone base 710 and handset 740 of FIG. 7. As illustrated, adapter 758 of interface device 750 physically and electrically mates the interface device to a conventional UART/USB/IRDA data cable connector 732 in cellular phone 730, while RJ11 phone connector 752 of interface device 750 connects the interface device to a conventional RJ11 phone connector 712 in cordless phone base 710 via wired link 706.

Microcontroller 755 is responsible for controlling the conversion of incoming cellular signals received from cellular phone 730 via adapter 758 for transmission as PSTN signals to cordless base 710 via connector 752 and, vice versa, for converting outgoing PSTN signals received from cordless base 710 via connector 752 for transmission as cellular signals to cellular phone 730 via adapter 758. As shown in FIG. 8, interface device 750 includes various filters, level converters, and signal conditioning circuits (753, 754, 756) well-known in the relevant arts to assure that proper conversion between cellular and PSTN signal formats takes place.

Using conventional cellular telephony technology, cellular phone 730 communicates with the cellular network, while cordless base 710 communicates with cordless handset 740 via cordless link 704 using conventional cordless telephony technology.

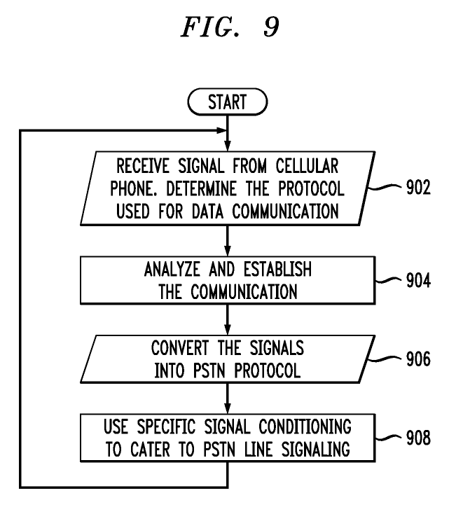

FIG. 9 is a flow diagram illustrating continuous processing in which interface device 750 converts incoming cellular telephone signals received from cellular phone 730 into incoming PSTN telephone signals for transmission to cordless phone base 710. The processing of FIG. 9 begins with receiving the cellular signal from the cellular phone and determining the protocol used for communication, as illustrated in step 902. The communication is then analyzed and established, per step 904, before converting the cellular signal into PSTN protocol, per step 906. Appropriate signal conditioning is performed, per step 908, to cater to the particular PSTN line signaling.

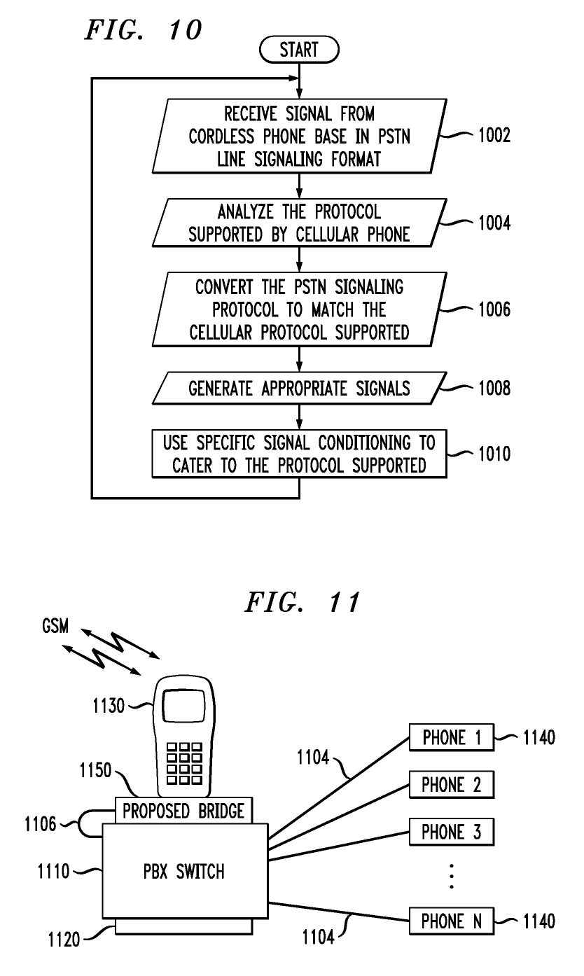

FIG. 10 is a flow diagram illustrating continuous processing in which interface device 750 converts outgoing PSTN telephone signals received from cordless phone base 710 into outgoing cellular telephone signals for transmission to cellular phone 730. The processing of FIG. 10 begins with receiving the PSTN signal from the cordless phone base in PSTN line signaling format, per step 1002. The cellular phone's communication protocol is analyzed in step 1004 to determine the cellular protocol supported by cellular phone 730. The PSTN-formatted signal is converted in step 1006 to a format matching the cellular phone's protocol, appropriate cellular signals are generated in step 1008 so as to match the communication protocol of the cellular phone, and the cellular signals are conditioned in step 1010.

### PBX Telephony Applications

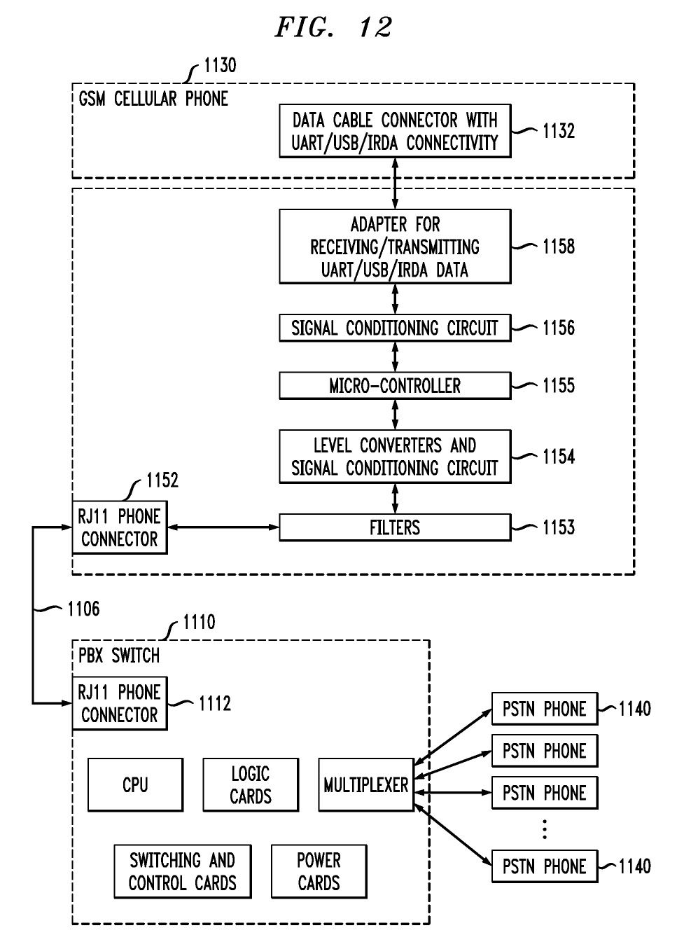

FIG. 11 illustrates another embodiment of the present invention in which an interface device 1150 (which is roughly analogous to interface device 750 of FIG. 7) is used to connect a conventional GSM (Global System for Mobile communications)-compatible cellular phone 1130 to a conventional PBX (private branch exchange, also known as private automatic branch exchange (PABX) and electronic PABX (EPABX)) switch 1110, even in locations or under situations where there is no PSTN service.

GSM cellular phone 1130 is capable of multi-channel transmission with a GSM network (not shown), where each channel may correspond to a different telephony signal. Alternatively, any mobile telephony device that is capable of multi-channel reception and transmission may be used in place of GSM cellular phone 1130.

When used for conventional PBX telephony applications, PBX switch 1110 is connected via a wired (e.g., RJ11) link to a conventional wired telephony network, such as the PSTN network. When so connected to the PSTN network, PBX switch 1110 demultiplexes an incoming multi-channel PSTN signal received from the PSTN network and routes one or more demultiplexed PSTN signals via wired links 1104 to one or more PSTN telephones 1140 in accordance with technology that is known to those of ordinary skill in the art. PBX switch 1110 also multiplexes outgoing PSTN signals received via wired links 1104 from the one or more PSTN telephones 1140 into a single multiplexed outgoing multi-channel PSTN signal for transmission to the PSTN network.

In the embodiment of FIG. 11, interface device 1150 converts between the multi-channel signals associated with GSM cellular phone 1130 and the multi-channel PSTN-based telephone signals associated with PBX switch 1110. Instead of connecting the PBX switch to the PSTN network via a wired link, the same conventional (e.g., RJ11) PSTN port of the PBX switch is used to connect the PBX switch to interface device 750 via wired link 1106. As such, the embodiment of FIG. 7 enables GSM cellular phone 1130 to be docked to PBX switch 1110, via interface device 1150, in a location of strong cellular signal receptivity, while the users use PSTN phones 1140 of the local PBX network to communicate with the cellular network, even in user locations with unsatisfactory cellular signal strength.

A motorized base 1120, similar to motorized base 720 previously described in connection with FIG. 7, can be attached to PBX switch 1110 for manual control of the orientation of cellular phone 1130.

FIG. 12 is a high-level block diagram of the circuitry used to implement interface device 1150, conventional GSM cellular phone 1130, and conventional PBX switch 1110 of FIG. 11. As illustrated, adapter 1158 of interface device 1150 physically and electrically mates the interface device to a conventional UART/USB/IRDA data cable connector 1132 in GSM cellular phone 1130, while RJ11 phone connector 1152 of interface device 1150 connects the interface device to a conventional RJ11 phone connector 1112 in PBX switch 1110 via wired link 1106.

Microcontroller 1155 is responsible for controlling the conversion of incoming multi-channel signals received from GSM cellular phone 1130 via adapter 1158 for transmission as multi-channel PSTN signals to PBX switch 1110 via connector 1152 and, vice versa, for converting outgoing multi-channel PSTN signals received from GSM cordless base 1130 via connector 1152 for transmission as multi-channel signals to GSM cellular phone 1130 via adapter 1158. As shown in FIG. 12, interface device 1150 includes various filters, level converters, and signal conditioning circuits well-known in the relevant arts to assure that proper conversion between multi-channel cellular and multi-channel PSTN signal formats takes place.

Using conventional GSM cellular telephony technology, GSM cellular phone 1130 communicates with the cellular network, while PBX switch 1110 communicates with PSTN phones 1140 via wired links 1104, using conventional PBX telephony technology.

In this fashion, a GSM cellular telephone can be mated to a local-area PBX telephone network for applications where PSTN telephony connection is not available as a main signal input, such as, but not limited to, in old buildings, at remote locations, at installations where PSTN networks have reached maximum capacity, or in any situation where an alternative local-area telephone network with GSM cellular connectivity is desired for economic or logistical reasons.

While the exemplary embodiments of the present invention have been described with respect to processes of circuits, including possible implementation as a single integrated circuit, a multi-chip module, a single card, or a multi-card circuit pack, the present invention is not so limited. As would be apparent to one skilled in the art, various functions of circuit elements may also be implemented as processing blocks in a software program. Such software may be employed in, for example, a digital signal processor, micro-controller, or general purpose computer.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Signals and corresponding nodes or ports may be referred to by the same name and are interchangeable for purposes here.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. Interface apparatus for interconnection of a cellular communication network and a local non-cellular communication network, the interface apparatus adapted to:
convert incoming cellular signals received from the cellular network into incoming non-cellular signals for transmission to the local non-cellular network; and
convert outgoing non-cellular signals received from the local non-cellular network into outgoing cellular signals for transmission to the cellular network.

2. The invention of claim 1, wherein:
the local non-cellular network is a local Bluetooth network;
the non-cellular signals are Bluetooth signals; and
the interface apparatus comprises a Bluetooth antenna adapted to transmit and receive Bluetooth signals to and from a Bluetooth device of the local Bluetooth network.

3. The invention of claim 2, wherein:
the Bluetooth device is a Bluetooth-enabled cellular phone;
the Bluetooth antenna is adapted to transmit and receive the Bluetooth signals to and from the Bluetooth-enabled cellular phone;
the interface apparatus further comprises:
a cellular antenna adapted to transmit and receive the cellular signals to and from the cellular network; and
a SIM-card port adapted to receive a SIM card associated with the Bluetooth-enabled cellular phone; and
with the SIM card connected to the SIM-card port, the interface apparatus is adapted to:
convert the incoming cellular signals received from the cellular network via the cellular antenna into incoming Bluetooth signals for transmission to the Bluetooth-enable cellular phone via the Bluetooth antenna; and
convert outgoing Bluetooth signals received from the Bluetooth-enabled cellular phone via the Bluetooth antenna into the outgoing cellular signals for transmission to the cellular network via the cellular antenna.

4. The invention of claim 2, wherein:
the interface apparatus further comprises a cell-phone adapter adapted to connect to a cellular phone; and
with the cellular phone connected to the cell-phone adapter, the interface apparatus is adapted to:
convert the incoming cellular signals received from the cellular network via the cellular phone into incoming Bluetooth signals for transmission to the Bluetooth device via the Bluetooth antenna; and
convert outgoing Bluetooth signals received from the Bluetooth device via the Bluetooth antenna into the outgoing cellular signals for transmission to the cellular network via the cellular phone.

5. The invention of claim 1, wherein:
the local non-cellular network is a cordless network having a cordless phone base and a cordless phone handset;
the interface apparatus comprises:
a cell-phone adapter adapted to connect to a cellular phone; and
a cordless-phone connector adapted to connect to the cordless phone base; and
with (1) the cellular phone connected to the cell-phone adapter and (2) the cordless phone base connected to the cordless-phone connector, the interface apparatus is adapted to:
convert the incoming cellular signals received from the cellular network via the cellular phone into incoming cordless-phone signals for transmission to the cordless phone base, wherein the cordless phone base converts the incoming cordless-phone signals into incoming wireless signals for transmission to the cordless phone handset; and
convert outgoing cordless-phone signals received from the cordless phone base into the outgoing cellular signals for transmission to the cellular network via the cellular phone, wherein the cordless phone base converts outgoing wireless signals received from the cordless phone handset into the outgoing cordless-phone signals.

6. The invention of claim 5, wherein:
the cordless-phone signals are PSTN telephony signals; and
the cordless-phone port is adapted to transmit and receive the PSTN telephony signals to and from the cordless phone base via a wired connection.

7. The invention of claim 1, wherein:
the local non-cellular network is a local PBX network having a PBX switch and one or more PSTN phones;
the interface apparatus comprises:
a cell-phone adapter adapted to connect to a cellular phone; and
a PBX-switch connector adapted to connect to the PBX switch; and
with (1) the cellular phone connected to the cell-phone adapter and (2) the PBX switch connected to the PBX-switch connector, the interface apparatus is adapted to:
convert incoming multi-channel cellular signals received from the cellular network via the cellular phone into incoming multi-channel PBX-switch signals for transmission to the PBX switch, wherein the PBX switch converts the incoming multi-channel PBX-switch signals into one or more incoming PSTN signals for transmission to the one or more PSTN phones; and
convert outgoing multi-channel PBX-switch signals received from the PBX switch into outgoing multi-channel cellular signals for transmission to the cellular network via the cellular phone, wherein the PBX switch converts one or more outgoing PSTN signals received from the one or more PSTN phones into the outgoing multi-channel PBX-switch signals.

8. The invention of claim 7, wherein:
the multi-channel PBX-switch signals are PSTN telephony signals; and
the PBX-switch port is adapted to transmit and receive the PSTN telephony signals to and from the PBX switch via a wired connection.

9. The invention of claim 1, further comprising a motorized base adapted to rotate the interface apparatus.

10. The invention of claim 9, wherein the motorized base is adapted to rotate the interface apparatus based on manual commands from a user.

11. The invention of claim 9, wherein the motorized base is adapted to rotate the interface apparatus based on signal-strength measurements of the cellular signals received from the cellular network.

12. The invention of claim 11, wherein the signal-strength measurements are provided to the interface apparatus from a cellular device connected to the interface apparatus.

13. A method for communicating between a cellular communication network and a local non-cellular communication network using an interface apparatus, the method comprising:
(a) converting incoming cellular signals received from the cellular network into incoming non-cellular signals for transmission to the local non-cellular network; and
(b) converting outgoing non-cellular signals received from the local non-cellular network into outgoing cellular signals for transmission to the cellular network.

14. The invention of claim 13, wherein:
the local non-cellular network is a local Bluetooth network; and
the non-cellular signals are Bluetooth signals.

15. The invention of claim 14, wherein:
the method further comprises mating the interface apparatus to a SIM card of a Bluetooth-enabled cellular phone;
step (a) comprises converting the incoming cellular signals received from the cellular network into incoming Bluetooth signals for transmission to the Bluetooth-enable cellular phone; and
step (b) comprises converting outgoing Bluetooth signals received from the Bluetooth-enabled cellular phone into the outgoing cellular signals for transmission to the cellular network.

16. The invention of claim 14, wherein:
step (a) comprises converting the incoming cellular signals received from the cellular network via a cellular phone into incoming Bluetooth signals for transmission to a Bluetooth device of the local Bluetooth network; and
step (b) comprises converting outgoing Bluetooth signals received from the Bluetooth device into the outgoing cellular signals for transmission to the cellular network via the cellular phone.

17. The invention of claim 13, wherein:
the local non-cellular network is a cordless network having a cordless phone base and a cordless phone handset;
the method further comprises mating the interface apparatus to a cellular phone and to the cordless phone base;
step (a) comprises converting the incoming cellular signals received from the cellular network via the cellular phone into incoming cordless-phone signals for transmission to the cordless phone base, wherein the cordless phone base converts the incoming cordless-phone signals into incoming wireless signals for transmission to the cordless phone handset; and
step (b) comprises converting outgoing cordless-phone signals received from the cordless phone base into the outgoing cellular signals for transmission to the cellular network via the cellular phone, wherein the cordless phone base converts outgoing wireless signals received from the cordless phone handset into the outgoing cordless-phone signals.

18. The invention of claim 13, wherein:
the local non-cellular network is a local PBX network having a PBX switch and one or more PSTN phones;
the method further comprises mating the interface apparatus to a cellular phone and to the PBX switch;
step (a) comprises converting incoming multi-channel cellular signals received from the cellular network via the cellular phone into incoming multi-channel PBX-switch signals for transmission to the PBX switch, wherein the PBX switch converts the incoming multi-channel PBX-switch signals into one or more incoming PSTN signals for transmission to the one or more PSTN phones; and
step (b) comprises converting outgoing multi-channel PBX-switch signals received from the PBX switch into outgoing multi-channel cellular signals for transmission to the cellular network via the cellular phone, wherein the PBX switch converts one or more outgoing PSTN signals received from the one or more PSTN phones into the outgoing multi-channel PBX-switch signals.

19. The invention of claim 13, further comprising rotating the interface apparatus using a motorized base based on manual commands from a user.

20. The invention of claim 13, further comprising rotating the interface apparatus using a motorized base based on signal-strength measurements of the cellular signals received from the cellular network, wherein the signal-strength measurements are provided to the interface apparatus from a cellular device connected to the interface apparatus.
